(19) United States
(12) Patent Application Publication
(10) Pub. No.: US 2020/0036266 A1
(43) Pub. Date: Jan. 30, 2020

(54) ELECTRIC ACTUATOR

(71) Applicant: Nidec Tosok Corporation, Zama-shi, Kanagawa (JP)

(72) Inventors: Yutaka UEMATSU, Zama-shi (JP); Kazumi SHINKAI, Zama-shi (JP); Shun KATO, Zama-shi (JP); Shuichi KINJO, Zama-shi (JP); Kohei OSUGA, Zama-shi (JP); Tadayuki HATSUDA, Zama-shi (JP)

(21) Appl. No.: 16/497,896

(22) PCT Filed: Mar. 20, 2018
(86) PCT No.: PCT/JP2018/011053

§ 371 Date: Sep. 26, 2019

(30) Foreign Application Priority Data
Mar. 31, 2017 (JP) 2017-070037

(51) Int. Cl. H02K 11/215; H02K 7/00; H02K 7/116

(52) U.S. Cl. CPC H02K 11/215; F16H 1/20; H02K 7/116; H02K 7/003

(57) ABSTRACT

An electric actuator includes a motor portion that includes a motor including a motor shaft extending axially, a decelerator that is joined to one axial side of the motor shaft, and an output portion that includes an output shaft to which rotation of the motor shaft is transmitted via the decelerator. The output shaft includes a joint portion joined to a driven shaft, the output portion includes a sensor magnet and a magnet holder which holds the sensor magnet, and the magnet holder is indirectly joined to the output shaft and is fixed to the driven shaft.

### CROSS REFERENCE TO RELATED APPLICATIONS

This is a U.S. national stage of PCT Application No. PCT/JP2018/011053, filed on Mar. 20, 2018, and priority under 35 U.S.C. § 119(a) and 35 U.S.C. § 365(b) is claimed from Japanese Application No. 2017-070037, filed Mar. 31, 2017; the entire disclosures of which are hereby incorporated herein by reference.

### 1. FIELD OF THE INVENTION

The present disclosure relates to an electric actuator.

### 2. BACKGROUND

In the related art, electric actuators including a motor and a decelerator are known. In this type of electric actuator, rotation position detecting means for detecting a rotation angle is provided in an output member joined to the decelerator (for example, refer to Japanese Patent Laid-open No. 2015-23761).

There are cases where an electric actuator is used while an output shaft of a decelerator and a driven side shaft are joined to each other. In this case, if there is play in a joint portion between the driven side shaft and the output shaft of the electric actuator, a sensor built into the electric actuator cannot accurately detect a rotation angle of the driven side shaft.

### SUMMARY

Example embodiments of the present disclosure provide electric actuators each including a sensor to detect a rotation angle of a shaft joined to an output shaft.

According to an example embodiment of the present disclosure, an electric actuator includes a motor portion that includes a motor including a motor shaft which extends axially, a decelerator that is joined to one axial side of the motor shaft, and an output portion that includes an output shaft to which rotation of the motor shaft is transmitted via the decelerator. The output shaft includes a joint portion which is joined to a driven shaft, the output portion includes a sensor magnet and a magnet holder which holds the sensor magnet, and the magnet holder is indirectly joined to the output shaft and is fixed to the driven shaft.

According to an example embodiment of the present disclosure, an electric actuator includes a sensor that detects a rotation angle of a shaft joined to an output shaft.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 illustrates a cross-sectional view of an electric actuator of an example embodiment of the present disclosure.

FIG. 2 illustrates a partial cross-sectional view of an output portion in the electric actuator.

FIG. 3 illustrates a perspective view of a magnet holder of an example embodiment of the present disclosure.

FIG. 4 illustrates a perspective view of the magnet holder.

FIG. 5 illustrates a cross-sectional view of the magnet holder.

FIG. 6 illustrates a perspective view of a holder spring of an example embodiment of the present disclosure.

FIG. 7 illustrates a state where the magnet holder is detached.

FIG. 8 illustrates a state where the magnet holder is attached.

FIG. 9 illustrates a step of attaching a driven shaft of an example embodiment of the present disclosure.

### DETAILED DESCRIPTION

### (Electric Actuator)

Hereinafter, electric actuators of example embodiments will be described with reference to the drawings.

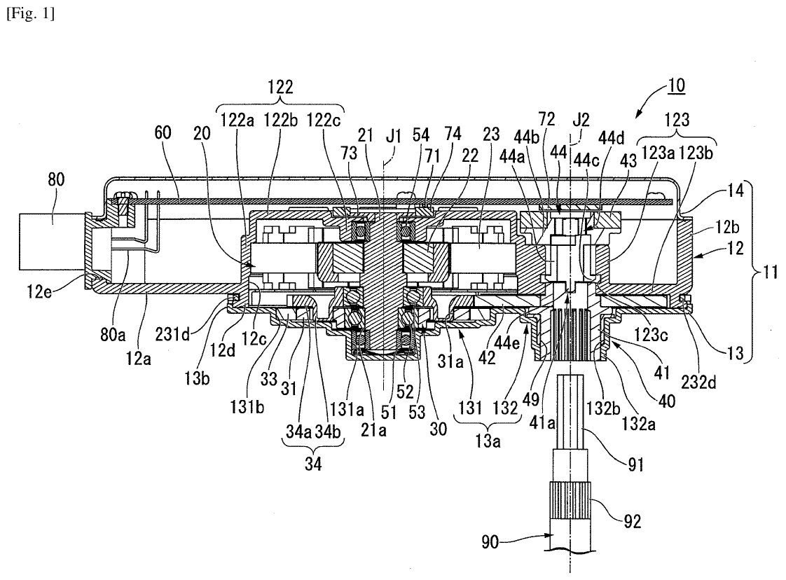

FIG. 1 illustrates a cross-sectional view of the electric actuator of the present example embodiment.

An electric actuator 10 of the present example embodiment is used by being joined to a driven shaft 90. The electric actuator 10 rotates the driven shaft 90 around an axis.

The electric actuator 10 includes a housing 11, a motor portion 20 that has a motor shaft 21 which extends axially along a first central axis J1, a deceleration mechanism 30, an output portion 40, a control board 60, a first bearing 51, a second bearing 52, a third bearing 53, a fourth bearing 54, and an external connector 80. The first bearing 51 to the fourth bearing 54 are ball bearings, for example. The axial direction of the first central axis J1 is parallel to the up-down direction in FIG. 1.

In the following description, the axial direction of the first central axis J1 will be simply referred to as “the axial direction”, axially upward in FIG. 1 will be simply referred to as “above or upward”, and axially downward in FIG. 1 will be simply referred to as “below or downward”. In addition, the radial direction about the first central axis J1 will be simply referred to as “the radial direction”, and the circumferential direction about the first central axis J1 will be simply referred to as “the circumferential direction”. Above (upward) and below (downward) are merely names for describing the relative positional relationship between portions. Actual disposition relationships or the like may be disposition relationships or the like other than disposition relationships or the like expressed using these names. Above (upward) corresponds to an axially opposite side, and below (downward) corresponds to one axial side.

The housing 11 has a housing main body 12 which accommodates the motor portion 20, the deceleration mechanism 30, and the output portion 40; a lower cover member 13 which is disposed on the side below the housing main body 12; and an upper cover member 14 which is disposed on the side above the housing main body 12.

The housing main body 12 is a bottomed box-shaped container which opens upward. The housing main body 12 has a bottom wall 12a which spreads in a direction orthogonal to the first central axis J1 and a circumferential wall 12b which extends upward from an outer circumferential end of the bottom wall 12a. The bottom wall 12a has a penetration hole 12c which axially penetrates the bottom wall 12a and a tubular protruding wall portion 12d which extends axially downward from an end edge of the penetration hole 12c. That is, the housing 11 has the penetration hole 12c and the protruding wall portion 12d.

The housing main body 12 has a motor holder 122 which holds the motor portion 20 and an output portion holder 123 which holds the output portion 40. The motor holder 122 and the output portion holder 123 are disposed radially side by side inside the penetration hole 12c. The housing main body 12 has a penetration portion 12e which radially penetrates the circumferential wall 12b. The external connector 80 is inserted into the penetration portion 12e and is fixed thereto.

The motor holder 122 has a cylindrical tube portion 122a which extends axially and a toric lid portion 122b which spreads radially inward from an upper end of the tube portion 122a. An opening portion of the tube portion 122a on the side below is positioned inside the penetration hole 12c. The tube portion 122a radially surrounds the outside of the motor portion 20. The lid portion 122b covers the side above the motor portion 20. The lid portion 122b has a cylindrical bearing holder 122c which holds the fourth bearing 54 in the middle.

The output portion holder 123 is disposed while being radially adjacent to the motor holder 122 inside the penetration hole 12c. The output portion holder 123 has a cylindrical tube portion 123a which extends axially with a second central axis J2 centered and a support wall portion 123b which spreads radially outward from a lower end of the tube portion 123a and is connected to a circumferential edge of the penetration hole 12c.

The protruding wall portion 12d surrounding the penetration hole 12c accommodates some of gears of the deceleration mechanism 30 and the output portion 40. In a region surrounded by the protruding wall portion 12d, a region axially overlapping the motor holder 122 is a region accommodating the gears of the deceleration mechanism 30, and a region axially overlapping the output portion holder 123 is a region accommodating the gears of the output portion 40.

The lower cover member 13 is fixed to the protruding wall portion 12d of the housing main body 12. The lower cover member 13 blocks the penetration hole 12c from the side therebelow. The lower cover member 13 has a lid plate portion 13a which spreads in a direction orthogonal to the axial direction and a tubular side wall portion 13b which extends axially upward from an end edge of the lid plate portion 13a. The side wall portion 13b surrounds the outer circumference of the protruding wall portion 12d of the housing main body 12 and face to a direction orthogonal to the axial direction. The side wall portion 13b of the lower cover member 13 is fixed to the protruding wall portion 12d by being caulked at a plurality of points.

The lower cover member 13 has a deceleration mechanism cover 131 which axially covers the deceleration mechanism 30 and an output portion cover 132 which axially covers the output portion 40.

The deceleration mechanism cover 131 has a disk shape about the first central axis J1 when viewed from the side therebelow. The deceleration mechanism cover 131 has a plurality of recessed accommodation portions 131a and 131b which are recessed downward. Both the recessed accommodation portions 131a and 131b have a bottomed cylindrical shape about the first central axis J1. The recessed accommodation portion 131a is disposed in a radially middle portion and accommodates the first bearing 51. The recessed accommodation portion 131b is positioned on the side above the recessed accommodation portion 131b and accommodates the gears of the deceleration mechanism 30.

The output portion cover 132 has a disk shape about the second central axis J2 when viewed from the side therebelow. The output portion cover 132 has a cylindrical tube portion 132a which extends axially downward with the second central axis J2 centered. The tube portion 132a has a penetration hole 132b which penetrates the output portion cover 132. A cylindrical bush 49 is disposed inside the tube portion 132a. The bush 49 is fitted into the penetration hole 132b. The bush 49 has a flange portion which protrudes radially outward in an upper end portion. The flange portion of the bush 49 comes into contact with the upper surface of the output portion cover 132 from the side thereabove.

The upper cover member 14 is fixed to an upper end portion of the circumferential wall 12b of the housing main body 12. The upper cover member 14 blocks an opening of the housing main body 12 on the side thereabove. The control board 60 is disposed between the upper surface of the motor holder 122 and the upper cover member 14. The control board 60 has a plate shape spreading in a direction orthogonal to the axial direction. Inside the housing main body 12, the control board 60 is fixed at a position where the motor holder 122 and the output portion holder 123 are covered from the side thereabove. The control board 60 is electrically connected to a coil wire which extends from the motor portion 20 and a metal terminal 80a which extends from the external connector 80.

The motor portion 20 has the motor shaft 21, a rotor 22, and a stator 23. The motor shaft 21 is rotatably supported around the first central axis J1 by the first bearing 51 and the fourth bearing 54. The motor shaft 21 extends downward from the rotor 22 and is joined to the deceleration mechanism 30.

The rotor 22 has a cylindrical rotor core which is fixed to an outer circumferential surface of the motor shaft 21 and a magnet which is fixed to an outer circumferential surface of the rotor core. The stator 23 has an annular stator core which radially surrounds the outside of the rotor 22 and a plurality of coils which are mounted on the stator core. The stator 23 is fixed to an inner circumferential surface of the tube portion 122a.

A ring-shaped sensor magnet 74 for a motor portion is attached to an upper end of the motor shaft 21 with a magnet holder 73 interposed therebetween. The magnet holder 73 and the sensor magnet 74 for a motor portion are disposed between the lid portion 122b of the motor holder 122 and the control board 60. A motor portion sensor 71 is disposed at a position in the control board 60 facing the sensor magnet 74 for a motor portion. The motor portion sensor 71 is a Hall element or an MR element (magneto-resistive element), for example. For example, three motor portion sensors 71 formed of Hall elements are disposed around the first central axis J1.

The deceleration mechanism 30 is disposed on the side below the motor portion 20. The motor shaft 21 axially penetrates the deceleration mechanism 30. The deceleration mechanism 30 is disposed on a side radially outward from a lower part of the motor shaft 21. The deceleration mechanism 30 is accommodated between the motor portion 20 and the deceleration mechanism cover 131. The deceleration mechanism 30 has an external gear 31, an internal gear 33, and an output gear 34.

The external gear 31 has a substantially toric plate shape spreading in a plane orthogonal to the axial direction about an eccentric portion 21a of the motor shaft 21. A gear portion is provided on a radially outer surface of the external gear 31. The external gear 31 is connected to the eccentric portion 21a with the second bearing 52 interposed therebetween. The external gear 31 has a plurality of pin holes 31a which axially penetrate the external gear 31. For example, eight pin holes are provided as the plurality of pin holes 31a. The plurality of pin holes 31a are disposed at equal intervals throughout the circumference around the central axis of the external gear 31.

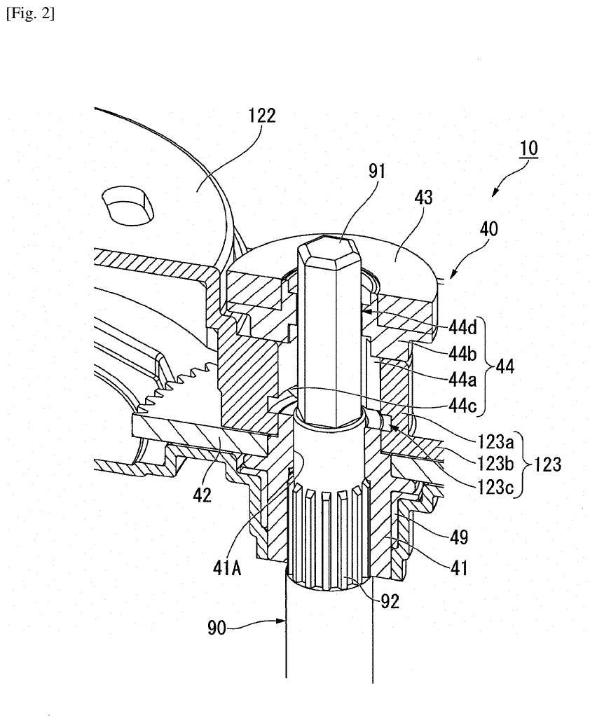

The internal gear 33 is fixed while radially surrounding the outside of the external gear 31 and meshes with the external gear 31. The internal gear 33 has a substantially toric shape about the first central axis J1. The external shape of the internal gear 33 is a polygonal shape (in the present example embodiment, a dodecagonal shape). The internal gear 33 is fitted into the recessed accommodation portion 131b of the deceleration mechanism cover 131 having the same polygonal shape (refer to FIG. 2) and is fixed thereto. The gear portion is provided on the inner circumferential surface of the internal gear 33. The gear portion of the internal gear 33 meshes with the gear portion of the external gear 31.

The output gear 34 is an external gear which is disposed on the side above the external gear 31. The output gear 34 has a toric portion 34a and a plurality of carrier pins 34b. The toric portion 34a has a toric plate shape radially spreading about the first central axis J1. The plurality of carrier pins 34b have a columnar shape protruding downward from the lower surface of the toric portion 34a. For example, eight carrier pins 34b are provided. The plurality of carrier pins 34b are disposed at equal intervals throughout the circumference about the first central axis J1. The carrier pins 34b are inserted into the pin holes 31a, respectively. The output gear 34 meshes with a driving gear 42 (which will be described below).

### (Output Portion)

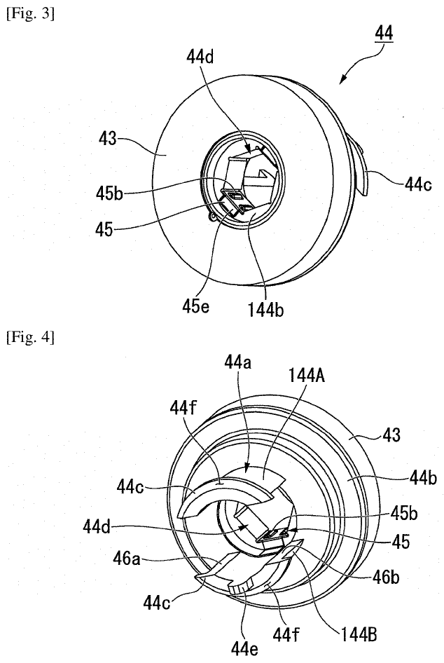

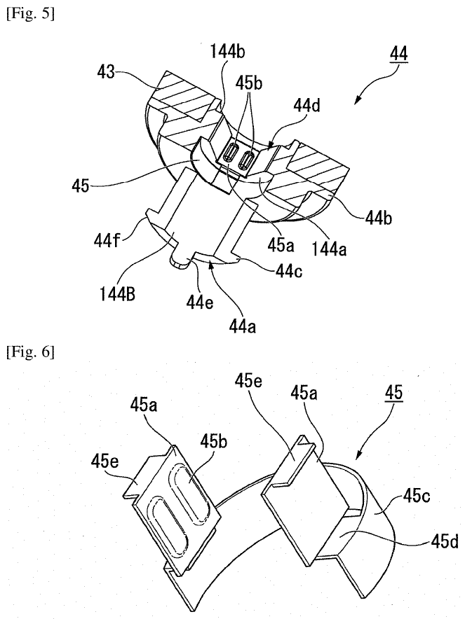

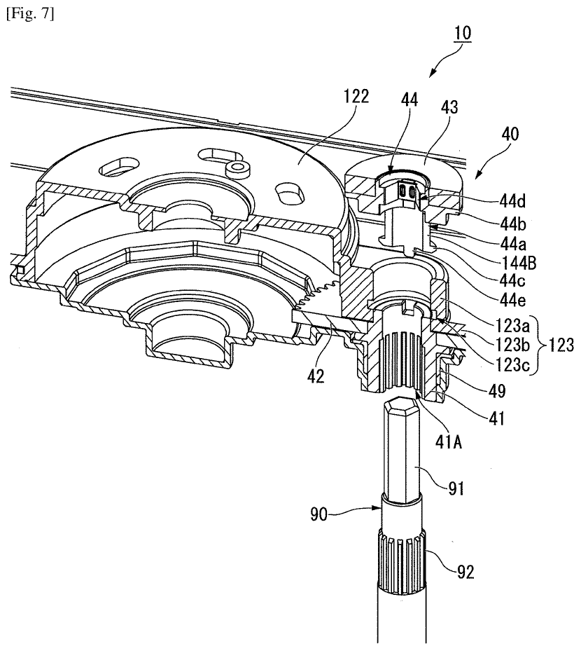

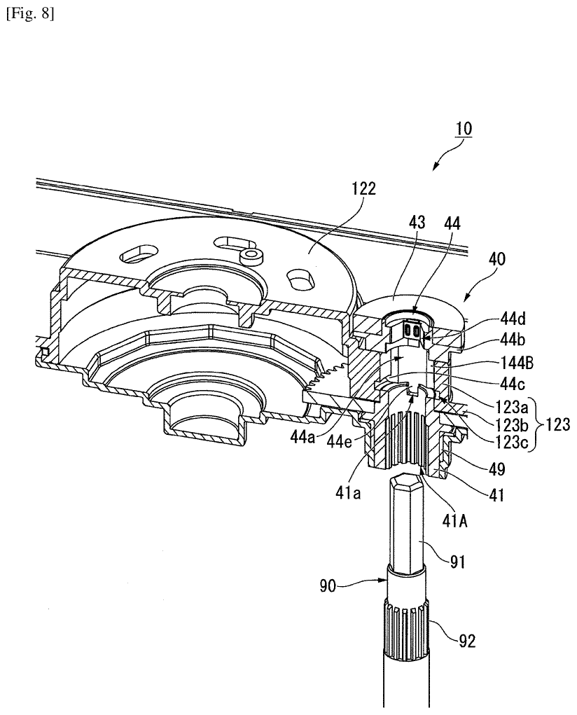

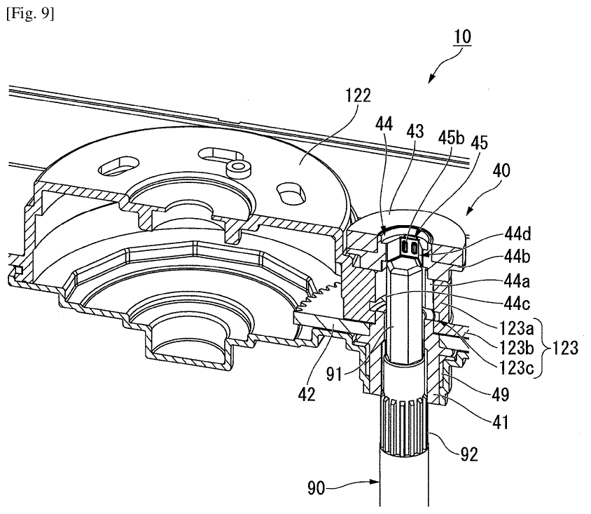

FIG. 2 illustrates a partial cross-sectional view of an output portion in the electric actuator 10. FIGS. 3 and 4 illustrate perspective views of a magnet holder. FIG. 5 illustrates a cross-sectional view of the magnet holder. FIG. 6 illustrates a perspective view of a holder spring. FIG. 7 illustrates a state where the magnet holder is detached. FIG. 8 illustrates a state where the magnet holder is attached. FIG. 9 illustrates a step of attaching a driven shaft.

In the drawings after FIG. 2, illustration of the motor portion and the deceleration mechanism will be suitably omitted.

The output portion 40 is a part outputting a driving force of the electric actuator 10. The output portion 40 has an output shaft 41, the driving gear 42, a sensor magnet 43 for an output portion, and a magnet holder 44. The output portion 40 is held by the output portion holder 123 and the output portion cover 132.

The output portion 40 can be joined to the driven shaft 90. In a distal end part inserted into the electric actuator 10, the driven shaft 90 has a hexagonal portion 91 which has a regular hexagonal shape in a cross section and a spline portion 92 which is positioned on a side below the hexagonal portion 91 (base end side of the driven shaft 90).

The output shaft 41 has a cylindrical shape extending along the second central axis J2. That is, as illustrated in FIGS. 2 and 7, the output shaft 41 has a shaft insertion hole 41A into which the driven shaft 90 is inserted. The output shaft 41 has a spline groove in a lower portion on the inner circumferential surface. That is, the shaft insertion hole 41A is a spline hole. When the spline portion 92 and the spline groove of the output shaft 41 are fitted to each other, the driven shaft 90 and the output shaft 41 are connected to each other. Due to this constitution, the driven shaft 90 can be driven at a high torque.

The output shaft 41 has a recessed portion 41a recessed axially at the upper end. The driving gear 42 is fixed to the outer circumferential surface of the output shaft 41. The driving gear 42 has a toric plate shape radially spreading about the second central axis J2. The lower portion of the output shaft 41 is inserted into the bush 49 of the output portion cover 132 from the side thereabove. The upper portion of the output shaft 41 is inserted into the tube portion 123a of the output portion holder 123 from the side therebelow.

The magnet holder 44 is a substantially cylindrical member extending along the second central axis J2. The magnet holder 44 has a tubular portion 44a which extends axially and a toric flange portion 44b which radially spreads from an upper portion of the tubular portion 44a. A toric sensor magnet 43 for an output portion is fixed to the upper surface of the flange portion 44b.

The tubular portion 44a of the magnet holder 44 is inserted into the tube portion 123a of the output portion holder 123. Since the output shaft 41 is inserted from the side below the tube portion 123a, the magnet holder 44 is positioned on the side above in a shaft insertion direction (up-down direction) with respect to the shaft insertion hole 41A of the output shaft 41. Due to this constitution, as illustrated in FIGS. 2 and 9, the driven shaft 90 can be inserted into the shaft insertion hole 41A of the output shaft 41 and the tubular portion 44a of the magnet holder 44 with one step of work.

The magnet holder 44 is positioned on the side above the output shaft 41 and on a side radially outward from the motor portion 20. Due to this constitution, in a constitution in which the motor portion 20 and the output portion 40 are radially arranged, the magnet holder 44 can be disposed by effectively utilizing the space inside the housing 11. Accordingly, the axial length of the electric actuator 10 can be reduced.

The magnet holder 44 has a movement restriction portion 44c formed of a projection protruding radially outward from the outer circumferential surface of the lower end portion of the tubular portion 44a. The movement restriction portion 44c is inserted into a recessed groove 123c which is provided on the inner circumferential surface of the tube portion 123a and extends circumferentially. The movement restriction portion 44c restricts axial movement of the magnet holder 44.

As illustrated in FIG. 4, the tubular portion 44a has cut-out portions 46a and 46b which extend axially from the side therebelow (output shaft 41 side). The lower portion of the tubular portion 44a is divided into two separate pieces 144A and 144B having an arc shape when viewed axially by the cut-out portions 46a and 46b. The movement restriction portion 44c extends circumferentially in an arc shape at the lower ends of the separate pieces 144A and 144B. Therefore, the movement restriction portion 44c is positioned between the cut-out portion 46a and the cut-out portion 46b.

In the separate pieces 144A and 144B, the end portion on the movement restriction portion 44c side can be radially bent while having the flange portion 44b side as a fixed end. As illustrated in FIGS. 7 and 8, in a step of attaching the magnet holder 44 to the tube portion 123a, the separate pieces 144A and 144B are bent and are inserted into the tube portion 123a of the output portion holder 123. When the magnet holder 44 is pressed to a predetermined position, the movement restriction portion 44c is fitted into the recessed groove 123c through snap-fitting. Accordingly, the magnet holder 44 can be prevented from being disengaged, and assembling workability is also improved. In addition, in a state where the driven shaft 90 is inserted into the tubular portion 44a (refer to FIG. 2), the separate pieces 144A and 144B are interposed between the driven shaft 90 and the inner surface of the tube portion 123a, and therefore radial deformation is limited. Accordingly, snap-fitting of the movement restriction portion 44c is unlikely to be released.

In the case of the present example embodiment, as illustrated in FIGS. 4 and 5, the lower surface of the movement restriction portion 44c has an inclination surface 44f which approaches the inner circumference going downward. Due to the inclination surface 44f, the tubular portion 44a can be easily inserted into the tube portion 123a from the side thereabove.

The magnet holder 44 has a hexagonal hole portion 44d having a hexagonal shape in a cross section on the upper portion side on the inner circumferential surface. When the hexagonal portion 91 of the driven shaft 90 is fitted into the hexagonal hole portion 44d of the magnet holder 44, the driven shaft 90 and the magnet holder 44 are connected to each other. The hexagonal hole portion 44d is positioned on a side radially inward from the sensor magnet 43 for an output portion. The magnet holder 44 has holder springs (elastic members) 45 which are positioned on two facing surfaces of six surfaces in the inner circumference of the hexagonal hole portion 44d.

As illustrated in FIG. 6, the holder spring 45 has two flat plate portions 45a which radially face each other and an arc-shaped support portion 45c which extends circumferentially. Each flat plate portion 45a has a plate-shaped lower plate portion 45d which extends radially outward from the lower end and a plate-shaped upper plate portion 45e which extends radially outward from the upper end. The flat plate portion 45a is connected to the support portion 45c with the lower plate portion 45d interposed therebetween. In each flat plate portion 45a, two projection portions 45b protruding radially inward from the flat plate portion 45a are provided on a radially inner surface.

As illustrated in FIGS. 3 to 5, two flat plate portions 45a are respectively disposed on two facing surfaces in the inner circumference of the hexagonal hole portion 44d. The lower plate portion 45d is disposed along a surface 144a which spreads radially outward from the opening end of the hexagonal hole portion 44d on the side therebelow. The support portion 45c is disposed circumferentially on the inner circumferential surface of the tubular portion 44a. The upper plate portion 45e is disposed along a surface 144b which spreads radially outward from the opening end of the hexagonal hole portion 44d on the side thereabove. Axial movement of the flat plate portion 45a is limited by the lower plate portion 45d and the upper plate portion 45e, and the flat plate portion 45a is fixed to the inner circumferential surface of the hexagonal hole portion 44d.

In the present example embodiment, as illustrated in FIG. 9, since the holder springs 45 are provided in the hexagonal hole portion 44d, the hexagonal portion 91 of the driven shaft 90 is press-fitted into the hexagonal hole portion 44d of the magnet holder 44. More specifically, when a side surface of the driven shaft 90 presses the projection portions 45b provided in the flat plate portion 45a of the holder spring 45 radially outward, the flat plate portion 45a and the lower plate portion 45d are mainly pressed and widened radially outward and are elastically deformed. When the elastically deformed holder springs 45 press the outer circumferential surface of the driven shaft 90, the magnet holder is fixed to the driven shaft 90 without wobbling. In the present example embodiment, since the holder springs 45 come into contact with the driven shaft 90 through the projection portions 45b, the contact area is reduced, and a pressure of pressing the side surface of the driven shaft 90 increases. Accordingly, the magnet holder 44 can be firmly fixed to the driven shaft 90.

The magnet holder 44 has a projection portion 44e which protrudes axially downward at the lower end of the tubular portion 44a. The projection portion 44e is inserted into the recessed portion 41a of the output shaft 41. Due to this constitution, the positions of the magnet holder 44 and the output shaft 41 can be aligned circumferentially. When the driven shaft 90 is inserted while being positionally aligned with the output shaft 41, the positions of the driven shaft 90 and the magnet holder 44 can be aligned circumferentially. As a result, the positions of the driven shaft 90 and the sensor magnet 43 for an output portion can be aligned circumferentially. Even if the magnet holder 44 is built into the housing 11 and cannot be visually recognized when the driven shaft 90 is attached, the positions of the sensor magnet 43 for an output portion and the driven shaft 90 can be easily aligned.

In addition, when the magnet holder 44 is inserted into the tube portion 123a, if the positions of the projection portion 44e and the recessed portion 41a do not coincide with each other, the magnet holder 44 cannot be pressed to the position where the movement restriction portion 44c is fitted into the recessed groove 123c. Therefore, the positions of the magnet holder 44 and the output shaft 41 can be reliably aligned at the time of assembling work.

The sensor magnet 43 for an output portion is disposed between the output portion holder 123 and the control board 60. An output portion sensor 72 is disposed at a position facing the sensor magnet 43 for an output portion of the control board 60. The output portion sensor 72 is an MR element, for example. An MR element and a Hall element may be used together as the output portion sensor 72.

In the electric actuator 10, the driven shaft 90 is fixed to the output shaft 41 and the magnet holder 44 which is a member independent from the output shaft 41. The output shaft 41 and the magnet holder 44 are positionally aligned by the recessed portion 41a and the projection portion 44e but are not fixed to each other. That is, the magnet holder 44 is indirectly joined to the output shaft 41 with the driven shaft 90 interposed therebetween. According to this constitution, since the magnet holder 44 is directly fixed to the driven shaft 90, the rotation angle of the driven shaft 90 can be accurately detected using the output portion sensor 72 without being affected by wobbling of spline fitting between the output shaft 41 and the driven shaft 90.

This application claims priority based on Japanese Patent Application No. 2017-070037, filed on Mar. 31, 2017, all the contents disclosed in the application are incorporated herein by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-8. (canceled)

9. An electric actuator comprising:
a motor portion that includes a motor including a motor shaft which extends axially;
a decelerator that is joined to one axial side of the motor shaft; and
an output portion that includes an output shaft to which rotation of the motor shaft is transmitted via the decelerator; wherein
the output shaft includes a joint portion which is joined to a driven shaft;
the output portion includes a sensor magnet and a magnet holder which holds the sensor magnet; and
the magnet holder is indirectly joined to the output shaft and is fixed to the driven shaft.

10. The electric actuator according to claim 9, wherein
the joint portion of the output shaft includes a shaft insertion hole into which the driven shaft is inserted; and
the magnet holder is disposed on a near side or a far side in a shaft insertion direction with respect to the shaft insertion hole.

11. The electric actuator according to claim 10, wherein
the magnet holder includes a tubular portion into which the driven shaft is inserted and an elastic member which causes a radial elastic force to act between an inner circumferential surface of the tubular portion and an outer circumferential surface of the driven shaft.

12. The electric actuator according to claim 11, wherein
the output portion includes a holder accommodation portion which surrounds the tubular portion of the magnet holder;
the holder accommodation portion includes a circumferentially extending recessed groove on an inner surface; and
the magnet holder includes a movement restriction portion which protrudes radially outward from an outer circumferential surface of the tubular portion and is inserted into the recessed groove.

13. The electric actuator according to claim 11, wherein
the magnet holder includes a projection portion which protrudes axially from an end portion of the tubular portion on the output shaft side; and
the output shaft includes a recessed portion into which the projection portion is inserted in an end portion on the magnet holder side.

14. The electric actuator according to claim 12, wherein
the tubular portion includes a plurality of cut-out portions which extend axially in the end portion on the output shaft side; and
the movement restriction portion is disposed between the cut-out portions adjacent to each other.

15. The electric actuator according to claim 10, wherein
the shaft insertion hole is a spline hole.

16. The electric actuator according to claim 9, wherein
the motor and the output portion are disposed radially side by side with respect to the motor;
the magnet holder and the output shaft are disposed axially side by side in the output portion; and
the magnet holder is positioned on a side radially outward from the motor.
